(19) United States
(12) Patent Application Publication
(10) Pub. No.: US 2018/0175741 A1
(43) Pub. Date: Jun. 21, 2018

(54) A GALVANICALLY ISOLATED RESONANT POWER CONVERTER ASSEMBLY

(71) Applicant: NPC Tech ApS, Herlev (DK)

(72) Inventors: Thomas Andersen, Valby (DK); Jakob Døllner Mønster, Copenhagen N (DK)

(21) Appl. No.: 15/736,737

(22) PCT Filed: Jun. 16, 2016
(86) PCT No.: PCT/EP2016/063816

§ 371 Date: Dec. 14, 2017

(30) Foreign Application Priority Data
Jun. 16, 2015 (EP) 15172306.1

(51) Int. Cl. H02M 7/493; H02M 3/335; H02M 7/537

(52) U.S. Cl. CPC H02M 7/493; H02M 2007/4815; H02M 7/537; H02M 3/33569

(57) ABSTRACT

The present invention relates in a first aspect to a galvanically isolated power converter assembly comprising a first set of electrically interconnected resonant power inverters configured for generating respective output voltages and output currents. The galvanically isolated power converter assembly further a first positive summing node and a first negative summing node configured to combining the output voltages and output currents of the first set of resonant power inverters and a first common load circuit comprising a positive load input and a negative load input. A galvanic isolation barrier comprises first and second common isolation capacitors electrically insulating the common load circuit. Each of the first and second common isolation capacitors possesses an official safety rating.

The present invention relates in a first aspect to a galvanically isolated power converter assembly comprising a first set of electrically interconnected resonant power inverters configured for generating respective output voltages and output currents. The galvanically isolated power converter assembly further a first positive summing node and a first negative summing node configured to combining the output voltages and output currents of the first set of resonant power inverters and a first common load circuit comprising a positive load input and a negative load input. A galvanic isolation barrier comprises first and second common isolation capacitors electrically insulating the common load circuit. Each of the first and second common isolation capacitors possesses an official safety rating.

### BACKGROUND OF THE INVENTION

Power density and component costs are key performance metrics of both isolated and non-isolated resonant DC-DC power converters to provide the smallest possible physical size and/or lowest costs for a given output power requirement or specifica-tion. Resonant power converters are particularly useful for high switching frequencies such as frequencies above 1 MHz where switching losses of standard SMPS topologies (Buck, Boost etc.) tend to be unacceptable for conversion efficiency reasons. High switching frequencies are generally desirable because of the resulting decrease of the electrical and physical size of circuit components of the power converter like inductors and capacitors. The smaller components allow increase of the power density of the resonant DC-DC power converter. In a resonant power converter an input “chopper” semiconductor switch (often MOSFET or IGBT) of the standard SMPS is replaced by a “resonant” semiconductor switch. The resonant semiconductor switch relies on resonances of a resonant network typically involving various circuit capacitances and inductances to shape the waveform of either the current or the voltage across the semiconductor switch such that, when state switching takes place, there is no current through or no voltage across the semiconductor switch. Hence power dissipation is largely eliminated in at least some of the intrinsic capacitances or inductances of the input semiconductor switch such that a dramatic increase of the switching frequency to values at or above 10 MHz or 20 MHz, for example into the VHF range, becomes feasible. This resonant switching mechanism is often designated zero voltage and/or zero current switching (ZVS and/or ZCS) operation. Commonly used switched mode power converters operating under ZVS and/or ZCS are often designated class E, class F or class DE power inverters or power converters.

However, it remains a significant challenge to find suitable semiconductor switching devices which can operate at high switching frequencies, such as above 1 MHz or above 30 MHz within the VHF range, and handle necessary device voltages and currents to produce a required output power of the resonant power converter for numerous types of applications. One known way of attacking this challenge has been to integrating multiple electrically interconnected resonant power inverters with lower individual output power capability on a single power converter assembly. The multiple resonant power inverters are connected in parallel to a common rectification circuit to multiply output power capability of the AC-DC or DC-DC power converter assembly relative to the output power capability of any individual resonant power inverter. However, if the power converter assembly must include a galvanic isolation barrier, for example to electrically insulate primary and secondary sections of the power converter assembly, a capacitive isolation barrier complying with an official safety rating for mains connected devices has traditionally been included in each of the individual resonant power inverters. However, the use of multiple interconnected individual resonant power inverters requires each resonant power inverter to include a safety rated galvanic isolation barrier to retain the galvanic isolation property of the entire power converter assembly. Unfortunately, isolation capacitors capable of complying with such official safety ratings are physically larger and more expensive than ordinary capacitors of similar capacitance without an official safety rating. Hence, the traditional application of safety rated isolation capacitors as capacitive isolation barriers for each individual resonant power inverter increases the dimensions and costs of the galvanically isolated power converter assembly in an undesir-able manner.

Hence, there is a need for various types of galvanically isolated power converter assemblies integrating multiple interconnected resonant power inverters and/or multiple interconnected load circuits with reduced component count, reduced manufacturing costs and reduced dimensions.

### SUMMARY OF THE INVENTION

A first aspect of the invention relates to a galvanically isolated power converter assembly comprising a first set of electrically interconnected resonant power inverters configured for generating respective output voltages and output currents. The galvanically isolated power converter assembly further a first positive summing node and a first negative summing node configured to combining the output voltages and output currents of the first set of resonant power inverters and a first common load circuit comprising a positive load input and a negative load input. A galvanic isolation barrier comprises a first common isolation capacitor coupled in series between the first positive summing node and the positive load input of the common load circuit and a second common isolation capacitor coupled in series between the first negative summing node and the negative load input of the first common load circuit. Each of the first and second common isolation capacitors possesses an official safety rating.

The outputs of the first set of resonant power inverters are connected in parallel by the superposition of the output voltages and output currents carried out at the first positive summing node and first negative summing node.

The official safety rating of the first and second common isolation capacitors is preferably an official safety rating for mains connected devices such as Y1, Y2, Y3, X1, X2 types of safety rating to ensure that the first common load circuit is appropriately insulated from the mains voltage. The official safety rating may comprise a safety rating complying with one or more official standards, such as IEC 60384-14:2005; IEC 60384-14:2013; EN 60950 2001; UL 60950-01 and EN 61347-2-13 or any other capacitor safety rating approved by a regulatory body. The official safety rating of the first and second common isolation capacitors retain the galvanic isolation property of the present galvanically isolated power converter assembly.

The skilled person will understand that each of the first and second common isolation capacitors in practice may comprise two or more series connected safety rated capacitors dividing a capacitor voltage. An Y1 rated first common isolation capacitor may for example be implemented as two series connected Y2 rated isolation capacitors. The same applies for the second common isolation capacitor.

The skilled person will understand that the sharing of the first and second common isolation capacitors between the first set of electrically interconnected resonant power inverters entails numerous advantages such as saving assembly board space, reducing component costs and reducing manufacturing costs etc.

The skilled person will understand that the first common load circuit may comprise a rectifier or rectification circuit or function embodying the galvanically isolated power converter assembly as a DC-DC power converter assembly generating a DC output voltage for a load of the assembly. Alternative embodiments of the galvanically isolated power converter assembly may be embodied as DC-AC power converter assemblies. Positive and negative inverter inputs of the first set of resonant power inverters may be coupled in parallel or in series to a dc or ac input voltage source.

The dc or ac input voltage may be derived from an available mains voltage such as 110 VAC-240 VAC for example by rectification and/or DC-DC step-down conversion such that the dc or ac input voltage is galvanically coupled to the mains distribution net.

Consequently, some embodiments of the galvanically isolated power converter assembly may comprise a positive power input and a negative power input for receipt of energy from a voltage source or a current source. The respective positive and negative inverter inputs of the first set of electrically interconnected resonant power inverters are coupled in series between the positive power input and the negative power input.

Alternative embodiments of the galvanically isolated power converter assembly may comprise a positive power input and a negative power input for receipt of energy from a voltage source or a current source. The respective positive and negative inverter inputs of the first set of electrically interconnected resonant power inverters are coupled parallel between positive power input and the negative power input.

The number of resonant power inverters of the first set of resonant power inverters may vary over a wide range depending on power requirement of any particular application. The first set of resonant power inverters may for example comprise two, three, four or more individual resonant power inverters such as between 5 and 200 individual resonant power inverters.

The resonant power inverters of the first set of resonant power inverters may possess identical circuit topologies. Different types of resonant power inverters may be utilized in the galvanically isolated DC-DC power converter assembly for example a resonant power inverter topology selected from a group of {class E, class F, class DE} or any converter topology derived therefrom such as resonant SEPIC topology, resonant boost topology, class φ₂ topology, LLC topology or LCC topology. A switching frequency of each of the resonant power inverters is preferably set to a value at or above 1 MHz or 10 MHz, or 20 MHz, such as a switching frequency in the VHF range at or above 30 MHz for the reasons discussed above. The high switching frequency makes it possible to use physically small and cheap converter capacitors. The skilled person will understand that each of the resonant power inverters of the first set thereof preferably comprises one or more semiconductor switch or switches with respective control terminals coupled to a control signal mod-ulated at the switching frequency. According to one embodiment of the galvanically isolated DC-DC power converter assembly, each resonant power inverter of the first set of resonant power inverters comprises an input side circuit comprising a positive and a negative input terminal for receipt of a first input voltage. A controllable switch arrangement of each resonant power inverter may be driven by a first switch control signal to set the switching frequency of the resonant power inverter. A resonant network of each resonant power inverter is coupled to an output of the first controllable switch arrangement to generate alternatingly increasing and decreasing resonant current in the resonant network in accordance with the first switch control signal to produce an output voltage between the positive and negative output nodes.

If the input sections of the first set of electrically interconnected resonant power inverters are connected in series between the positive power input and the negative power input, the outputs of the resonant power inverters must be appropriately dc isolated from each other to prevent avoid disturbance of their proper DC bias points as discussed in further detail below with reference to the appended drawings. This is accomplished in one embodiment of the galvanically isolated power converter assembly wherein each resonant power inverter, of the first set of electrically interconnected resonant power inverters, comprises at least one of a first converter capacitor connected in series with a positive output node and a second converter capacitor in series with a negative output node. The at least one of the first and second converter capacitors lacks an official safety rating. If the resonant power inverter in question comprises both the first and second converter capacitors each of these may lack an official safety rating to minimize costs and dimensions of the converter capacitors.

The positive output node of a single resonant power inverter may lack the first converter capacitor and the negative output node of a single resonant power inverter may lack the second converter capacitor for the reasons discussed in further detail below with reference to the appended drawings. Hence, if the first set of electrically interconnected resonant power inverters comprises N individual resonant power inverters, the number of first converter capacitors may be N−1 and the number of second converter capacitors may be N−1; where N is a positive integer larger than 1. That embodiment minimizes the total number of capacitors of the converter assembly.

The first converter capacitor may be connected between the positive output node of the resonant power inverter and the positive summing node and/or the second converter capacitor may be connected between the negative output node of the resonant power inverter and the first negative summing node.

One or both of the first and second converter capacitors may possess a first breakdown voltage rating and one or both of the first and second common isolation capacitors may possess a second breakdown voltage rating. The second breakdown voltage rating is preferably higher than the first breakdown voltage rating. This dif-ference between the first and second breakdown voltage ratings will often make the physical dimensions of the first and/or second converter capacitors smaller than the physical dimensions of the first and/or second common isolation capacitors. The second breakdown voltage rating of the first and second common isolation capacitors may for example be higher than 250 VAC, 400 VAC or 1000 VAC such as higher than 1500 VAC. The first breakdown voltage rating may for example be less than 240 VAC. One or both of the first and second common isolation capacitors may comprise a surface mount compatible ceramic chip capacitor. A capacitance of each of the first and second common isolation capacitors may be larger than 10 pF, such as between 100 pF and 20 nF, as discussed in additional detail below with reference to the appended drawings.

Resonant networks of the first set of resonant power inverters may comprise a shared resonant inductor coupled between the positive summing node and the positive input terminal of the first common load circuit and thereby placed in series with the first common isolation capacitor as discussed in additional detail below with reference to the appended drawings. Each of the resonant networks may comprise one or more capacitors and one or more inductors. The capacitors may comprise intrinsic semiconductor device capacitances of the semiconductor switch or switches of the resonant power inverters.

The first set of resonant power inverters may be magnetically coupled to each other to synchronize resonant current and voltage waveforms between individual resonant power inverters including the output voltages and output current waveforms as discussed in additional detail below with reference to the galvanically isolated DC-DC power converter disclosed on the appended FIG. 6.

According to yet another embodiment of the galvanically isolated power converter assembly, the magnetic coupling of the first set of galvanically isolated resonant power inverters is configured to force substantially identical switching frequencies of the individual resonant power inverters. The magnetic coupling may be configured to force substantially zero degree phase shift between resonant current and voltage waveforms of the resonant power inverters. The zero degree phase shift between the corresponding resonant voltage and current waveforms of the resonant power inverters allows the respective output voltages at the output nodes to be combined or added constructively to form a maximal combined output voltage at the input of the common load circuit because of their in-phase relationship. Alternatively, a certain amount of phase shift between the corresponding resonant voltage and current waveforms may be utilized to adjust a level of the combined output voltage at the input of the common load circuit.

Certain embodiments of the present galvanically isolated power converter assembly may comprise one or more additional set(s) of electrically interconnected resonant power inverters connected to respective load circuits for example to provide multiple independent DC voltage outputs or AC voltage outputs. According to one such embodiment, the galvanically isolated power converter assembly comprises a second set of electrically interconnected resonant power inverters configured for generating respective output voltages and output currents and a second positive summing node and a second negative summing node configured to combining the output voltages and output currents of the second set of resonant power inverters. The assembly further comprises a second common load circuit comprising a positive load input and a negative load input and a third common isolation capacitor coupled in series between the second positive summing node and the positive load input of the second common load circuit and a fourth common isolation capacitor coupled in series between the second negative summing node and the negative load input of the second common load circuit. Each of the third and fourth common isolation capacitors possesses the previously discussed official safety rating. An output of the first common load circuit and an output of the second common load circuit may be coupled in series between positive and negative load connection terminals of the galvanically isolated power converter assembly. A DC output voltage of the galvanically isolated power converter assembly may be supplied through these positive and negative load connection terminals.

A second aspect of the invention relates to a galvanically isolated power converter assembly, which comprises a plurality of electrically interconnected load circuits which are coupled to a common resonant power inverter through a pair of shared safety rated isolation capacitors. Hence, this second aspect of the invention may relate to a galvanically isolated power converter assembly comprising a first set of electrically interconnected load circuits comprising respective positive and negative load inputs. The assembly further comprises a common resonant power inverter configured to generate a resonant output voltage between a positive inverter output node and negative inverter output node and a galvanic isolation barrier comprising a first common isolation capacitor coupled between the positive summing node and the positive inverter output node and a second common isolation capacitor coupled in series between the negative summing node and the negative inverter output node. Each of the first and second common isolation capacitors possesses the previously discussed official safety rating.

Each load circuit, of the first set of electrically interconnected load circuits, may comprise at least one of a first load capacitor having a first terminal coupled to the positive load input and a second load capacitor having a first terminal coupled to the negative load input. The at least one of the first and second load capacitors lacks an official safety rating. Additionally, a second terminal of each of the first load capacitors is connected to the positive summing node and a second terminal of each of the second load capacitors is connected to the negative summing node to arrange the positive load inputs and the negative load inputs electrically in parallel.

The physical and electrical characteristics of the first and second load capacitors may be identical to the previously discussed physical and electrical characteristics of the first and second converter capacitors in accordance with the first aspect of the invention. The skilled person will understand physical and electrical characteristics of the common resonant power inverter may be identical any of the previously discussed resonant power inverters in accordance with the first aspect of the invention.

The galvanically isolated power converter assembly may comprise at least one additional common resonant power inverter with positive and negative inverter output nodes coupled in parallel to the positive and negative inverter output nodes of the common resonant power inverter. However, in this instance the positive and negative inverter output nodes of each of the two or more common resonant power inverters are ac coupled through serially arranged converter capacitors to the galvanic isolation barrier as discussed in additional detail below with reference to the appended drawings. Each of the serially arranged converter capacitors is preferably without an official safety rating such that the safety rated galvanic isolation of the galvanically isolated power converter assembly may be carried out by only two offi-cially safety rated capacitors, i.e. the first and second common isolation capacitors, despite the possible presence of a large number of common resonant power inverters and a large number of electrically interconnected load circuits.

### BRIEF DESCRIPTION OF THE DRAWINGS

Preferred embodiments of the invention are described in more detail below in connection with the appended drawings, in which:

FIG. 1 is a schematic block diagram of a prior art galvanically isolated DC-DC power converter assembly,

FIG. 2 shows a schematic block diagram of a galvanically isolated DC-DC power converter assembly comprising a plurality of serially interconnected individual resonant power inverters in accordance with a first embodiment of the invention,

FIG. 2A shows a schematic block diagram of a galvanically isolated DC-DC power converter assembly comprising a plurality of serially interconnected individual resonant power inverters in accordance with a second embodiment of the invention,

FIG. 2B shows a schematic block diagram of a galvanically isolated DC-DC power converter assembly comprising a plurality of parallelly interconnected individual resonant power inverters in accordance with a third embodiment of the invention,

FIG. 3 shows a schematic block diagram of a galvanically isolated DC-DC power converter assembly comprising two sets of serially interconnected individual resonant power inverters in accordance with fourth embodiment of the invention,

FIG. 4 shows a schematic block diagram of a galvanically isolated DC-DC power converter assembly comprising a plurality of interconnected individual rectification circuits in accordance with a fifth embodiment of the invention,

FIG. 4A shows a schematic block diagram of a galvanically isolated DC-DC power converter assembly comprising a plurality of interconnected individual rectification circuits in accordance with an sixth embodiment of the invention,

FIG. 5 shows a schematic block diagram of a galvanically isolated DC-DC power converter assembly comprising a set of interconnected individual resonant power inverters coupled to a plurality of interconnected individual rectification circuits via first and second safety capacitors in accordance with an seventh embodiment of the invention; and

FIG. 6 is a schematic circuit diagram of a galvanically isolated DC-DC power converter assembly comprising first and second magnetically coupled resonant isolated class E power inverters in accordance with an eight embodiment of the invention.

### DETAILED DESCRIPTION OF PREFERRED EMBODIMENTS

Various exemplary embodiments of the present power converter assemblies are described in the following with reference to the appended drawings. The skilled person will understand that the accompanying drawings are schematic and simplified for clarity and therefore merely show details which are essential to the understanding of the invention, while other details have been left out. Like reference numerals refer to like elements or components throughout. Like elements or components will therefore not necessarily be described in detail with respect to each figure.

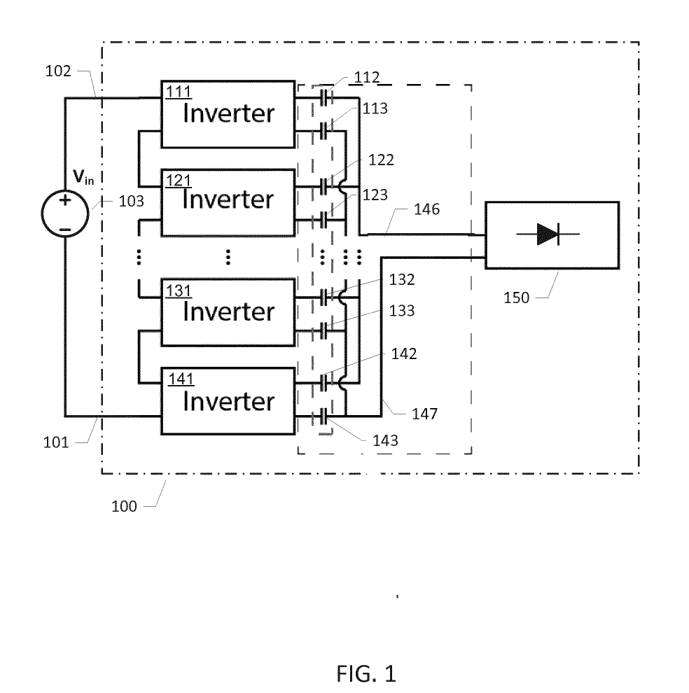

FIG. 1 is a simplified block diagram of a prior art galvanically isolated DC-DC power converter assembly 100 comprising a plurality of interconnected resonant power inverters 111,121,131,141. Input side circuits of the plurality of interconnected resonant power inverters 111,121,131,141 are coupled in series electrically between a positive input terminal 102 and a negative input terminal 101 of the assembly 100 for receipt of a dc or rectified ac input voltage Vin from a voltage or power source 103. Output side circuits of the plurality of interconnected resonant power inverters 111, 121,131,141 are coupled electrically in parallel to a common rectification circuit 150. The respective output currents and output voltages of the plurality of interconnected resonant power inverters 111,121,131,141 are summed at a positive summing node 146 and a negative summing node 147 connected to positive and negative input terminals, respectively, of the common rectification circuit 150. To provide galvanic isolation in the assembly 100, each of the resonant power inverters comprises a first isolation capacitor in series with a positive output node and a second isolation capacitor in series with a negative output node. The first resonant power inverter 111 comprises the first isolation capacitor 112 in series with a positive output node, coupled to the positive summing node 146, and the second isolation capacitor 113 in series with the negative output node. Hence, these first and second isolation capacitors 112, 113 function as a capacitive galvanic isolation barrier of the first resonant power inverter 111 to electrically insulate the primary side/input circuit of the power inverter 111 from the common rectification circuit 150. Each of the residual resonant power inverters 121, 131, 141 includes a corresponding capacitive galvanic isolation barrier formed by respective pairs of isolation capacitors 122, 123, 132, 133, 142, 143. Each of these eight isolation capacitors 112, 113, 122, 123, 132, 133, 142 and 143 possesses an official safety rating for mains connected devices such as Y1, Y2, Y3, X1, X2 safety ratings to ensure that the output of each of the resonant power inverters is appropriately insulated from the mains. However, these isolation capacitors 112, 113, 122, 123, 132, 133, 142, 143 are physically larger and more expensive than ordinary capacitors of corresponding capacitance without official safety rating. Hence, the use of numerous safety rated isolation capacitors 112, 113, 122, 123, 132, 133, 142 and 143 increases dimensions and costs of the DC-DC power converter assembly 100 as previously discussed and the skilled person will understand that this problem grows in proportion with the number of interconnected resonant power inverters of a particular power converter assembly.

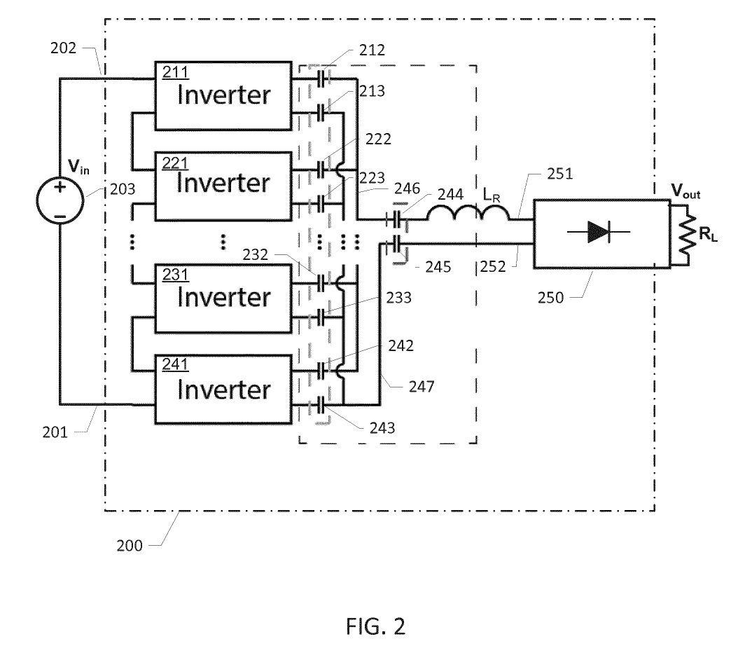

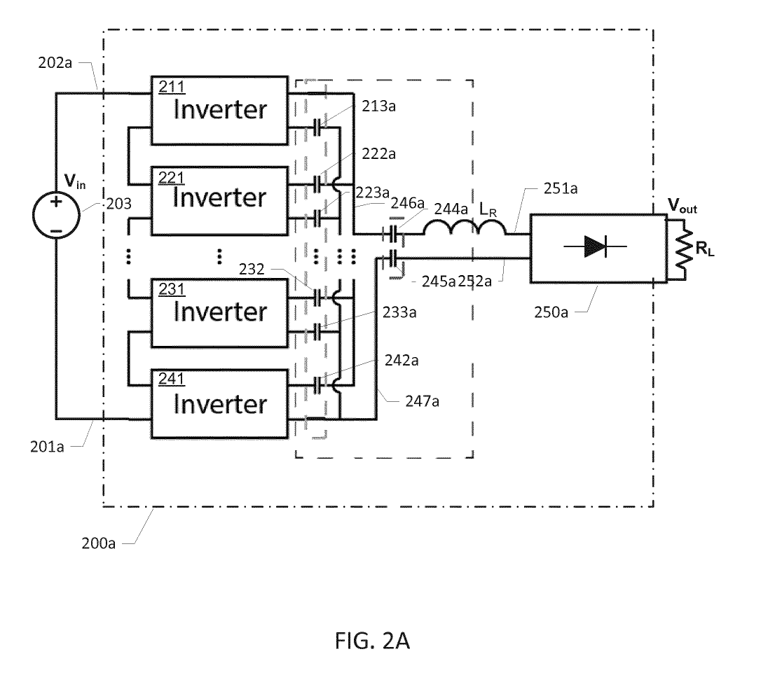

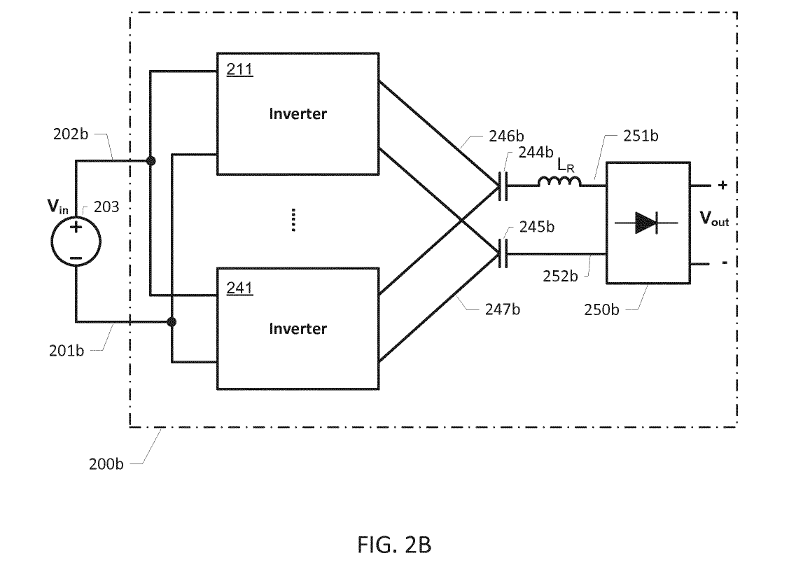

FIG. 2 shows a schematic block diagram of a galvanically isolated DC-DC power converter assembly 200 comprising a plurality of electrically interconnected individual resonant power inverters 211, 221, 231, 241 in accordance with a first embodiment of the invention. Inputs of the plurality of electrically interconnected individual resonant power inverters 211, 221, 231, 241 are serially connected to a dc or ac voltage or power source 203. The skilled person will understand that alternative embodiments of the galvanically isolated DC-DC power converter assembly 200 may comprise less than four individual resonant power inverters, for example two or three resonant power inverters, while other embodiments may comprise more than four individual resonant power inverters, for example five or more individual resonant power inverters. The plurality of interconnected individual resonant power inverters 211, 221, 231, 241 may possess identical circuit topologies. Different types of resonant power inverters 211, 221, 231, 241 may be utilized in the galvanically isolated DC-DC power converter assembly 200, for example a power inverter topology selected from a group of {class E, class F, class DE} or any converter topology derived therefrom such as resonant SEPIC topology, resonant boost topology, class φ₂ topology, LLC topology or LCC topology.

The respective positive and negative inverter inputs or terminals of the plurality of interconnected resonant power inverters 211, 221, 231, 241 are coupled electrically in series between a positive input terminal 202 and a negative input terminal 201 of the assembly 200 for receipt of a dc (DC) or ac (AC) input voltage Vᵢₙ from an external voltage or power source 203. Consequently, the dc or ac input voltage Vᵢₙ is divided between the individual resonant power inverters 211, 221, 231, 241 to produce a certain input voltage across each set of positive and negative inverter inputs. Consequently, the input voltage applied to each of the resonant power inverters 211, 221, 231, 241 may be significantly reduced relative to the dc or ac input voltage Vᵢₙ of the assembly 200. This feature significantly reduces the voltage handling requirements imposed on active and passive components of each of the resonant power inverters. The dc or ac input voltage Vᵢₙ may for example be divided equally between four individual resonant power inverters 211, 221, 231, 241 to produce an input voltage of ¼ of Vᵢₙ across each set of positive and negative inverter inputs. The dc or ac input voltage Vᵢₙ may be derived from a mains voltage such as 110 VAC-240 VAC for example by rectification and/or DC-DC step-down conversion such that Vᵢₙ is galvanically coupled to the mains distribution net. The skilled person will understand that the positive and negative inverter inputs of the plurality of interconnected resonant power inverters 211, 221, 231, 241 in the alternative may be connected in parallel between the positive input terminal 202 and the negative input terminal 201 in other embodiments of the galvanically isolated DC-DC power converter assembly 200. Inverter outputs of the plurality of interconnected resonant power inverters 211, 221, 231, 241 are coupled electrically in parallel to a common load circuit 250. The common load circuit 250 comprises a rectification circuit in the present embodiment of the invention to produce a DC output voltage Vₒᵤₜ. The skilled person will understand that the load circuit in other embodiments of the galvanically isolated DC-DC power converter assembly 200 may lack the rectifier portion or function in effect converting the assembly to a DC-AC power converter assembly.

The respective output currents and output voltages of the plurality of interconnected resonant power inverters 211, 221, 231, 241 are summed at a positive summing node 246 and a negative summing node 247. The positive summing node 246 and the negative summing node 247 are connected, through a galvanic isolation barrier comprising a pair of isolation capacitors 244, 245, to positive and negative load inputs 251, 252, respectively, of the common load circuit 250. The skilled person will understand that the plurality of interconnected resonant power inverters 211, 221, 231, 241 are preferably coupled to each other by a suitable mechanism for example magnetically as mentioned above such that resonant power inverters 211, 221, 231, 241 are operating substantially in phase. The latter condition may be helpful in some embodiments to ensure optimum conversion efficiency and generation of maximum ac output voltage and current at the positive and negative summing nodes 246, 247. The switching frequency of each of the resonant power inverters 211, 221, 231, 241 is preferably set to value at or above 1 MHZ such as above 10 MHz for example a switching frequency in the VHF range at or above 30 MHz for the reasons discussed above.

The common load or rectification circuit 250 generates a dc output voltage Vₒᵤₜ across a load. The load of the galvanically isolated DC-DC power converter assembly 200 is schematically illustrated by load resistor R_{L}. The plurality of interconnected resonant power inverters 211, 221, 231, 241 may be magnetically coupled to each other in addition to the above-mentioned electrical series connection of the inputs of the individual resonant power inverters 211, 221, 231, 241. The optional magnetic coupling of the plurality of resonant power inverters 211, 221, 231, 241 may be configured to synchronize resonant current and voltage waveforms between individual resonant power inverters including the output voltages and output current waveforms as discussed in further detail below with reference to a galvanically isolated DC-DC power converter assembly 600 comprising first and second magnetically coupled resonant isolated class E inverters.

In the present power converter assembly 200 each of the resonant power inverters 211, 221, 231, 241 comprises a first converter capacitor in series with a positive output node of the resonant power inverter and a second converter capacitor in series with a negative output node of the resonant power inverter similarly to the above discussed prior art galvanically isolated DC-DC power converter assembly 100. Hence, the first resonant power inverter 211 comprises the first converter capacitor 212 in series with a positive output node, coupled to the positive summing node 246, and the second converter capacitor 213 in series with the negative output node. However, in contrast to the prior art galvanically isolated DC-DC power converter assembly 100, the first and second series capacitors are ordinary capacitors, such as SMD compatible ceramics capacitors, without or lacking any official safety rating. Hence, these first and second converter capacitors 212, 213 do not provide a safety rated galvanic isolation of the first resonant power inverter 211 in contrast to the function of the corresponding first and second isolation capacitors 112, 113 of the prior art galvanically isolated DC-DC power converter assembly 100 despite their corresponding arrangement in the circuit topologies. Each of the residual resonant power inverters 221,231, 241 includes corresponding first and second ordinary series capacitors 222, 223, 232, 233, 242, 243 without official safety rating. Instead the first and second isolation capacitors 244, 245 provide the safety rated or safety compliant isolation from the mains of the galvanically isolated DC-DC power converter assembly 200. The first isolation capacitor 244 is placed in-between the positive summing node 246 and a positive rectifier or load input 251 through an intervening shared resonant inductor L_{R}. The second isolation capacitor 245 is placed in-between the negative summing node 247 and a negative rectifier input 252. The skilled person will appreciate that the circuit locations of the first isolation capacitor 244 and the shared resonant inductor L_{R} may be swapped such that the first isolation capacitor 244 is coupled directly to the positive rectifier or load input 251. In other embodiments of the galvanically isolated DC-DC power converter assembly 200, the shared resonant inductor L_{R} is replaced with individual resonant inductors arranged in a resonant network of each of the resonant power inverters 211, 221, 231, 241. Each of the first and second isolation capacitors 244, 245 possesses an official safety rating for mains connected devices such as one of Y1, Y2, Y3, X1, X2 safety ratings. The official safety rating of the first and second isolation capacitors 244, 245 may comply with one or more official standards selected from a group of {IEC 60384-14:2005; IEC 60384-14:2013; EN 60950 2001; UL 60950-01; EN 61347-2-13}.

This safety rating ensures that the combined output of the resonant power inverters 211, 221, 231, 241 is appropriately insulated from the common rectification circuit 250 such that primary side circuitry of the DC-DC power converter assembly 200 is electrically insulated from the secondary side circuitry of the DC-DC power converter assembly 200. Each of the first and second capacitors 212, 213 typically possesses a first breakdown/withstanding voltage rating, which is significantly lower than a breakdown/withstanding voltage rating of each of the first and second isolation capacitors 244, 245. The skilled person will appreciate that the eight safety rated isolation capacitors 112, 113, 122, 123, 132, 133, 142, 143 of the prior art galvanically isolated DC-DC power converter assembly 100 has been replaced by merely two safety rated isolation capacitors 244, 245 in the present DC-DC power converter assembly 200. While the present DC-DC power converter assembly 200 also comprises eight converter capacitors 212, 213, 222, 223, 232, 233, 242 and 243, these are ordinary capacitors without any official safety rating. Hence, each of these eight ordinary capacitors 212, 213, 222, 223, 232, 233, 242 and 243 may be a small and cheap SMD compatible ceramics capacitor such that significant size and costs savings are achieved by replacing the eight safety rated isolation capacitors 112, 113, 122, 123, 132, 133, 142, 143 of the prior art galvanically isolated DC-DC power converter assembly 100 by only two safety rated isolation capacitors 244, 245. These cost and size savings are obtained despite that the total number of series capacitors of the present DC-DC power converter assembly 200 is larger than the prior art DC-DC power converter assembly 100.

The role of these eight ordinary converter capacitors 212, 213, 222, 223, 232, 233, 242 and 243 in the present DC-DC power converter assembly 200 is to provide ac coupling, or dc isolation, between the individual resonant power inverters 211, 221, 231 and 241. This ac coupling mechanism is needed because the individual resonant power inverters 211, 221, 231 and 241 are operating at different dc bias voltages or dc bias points due to the series connection of the inverter inputs as discussed above. The respective positive and negative output nodes of the resonant power inverters 211, 221, 231 and 241 therefore need to be ac coupled before combining or summing the output voltages and currents at the positive and negative summing nodes 246, 247 to avoid disturbance of the proper dc operating point of each of the resonant power inverters. However, a single capacitor of the four ordinary converter capacitors 212, 222, 232, and 242, which are connected to the positive summing node 246 may be dispensed with. This is feasible because the DC output voltage of the resonant power inverter in question may be applied to the positive summing node 246 as long as the outputs of the residual resonant power inverters, e.g. three resonant power inverters in the present embodiment, are ac coupled, i.e. dc isolated, from the positive summing node 246 and therefore remain un-disturbed by the dc potential present at the positive summing node 246. Likewise, a single capacitor of the four ordinary converter capacitors 213, 223, 233, and 243, which are connected to the negative summing node 247, may in a corresponding manner be dispensed with. Such an alternative embodiment of the present power converter assembly is disclosed below in connection with FIG. 2A.

Reverting to the present power converter assembly 200, each of the first and second isolation capacitors 244, 245 may possess a breakdown voltage rating/withstanding voltage rating higher than 1000 VAC, preferably higher than 1500 VAC. Each of the first and second isolation capacitors 244, 245 may comprise a surface mountable ceramic chip capacitor. The capacitance of each of the first and second isolation capacitors 244, 245 may be larger than 10 pF such as between 100 pF and 20 nF depending on specific performance requirements of the present DC-DC power converter assembly 200. Each of the first and second isolation capacitors 244, 245 may comprise a Johanson Dielectrics Type SC ceramic chip capacitor comprising NP0 and X7R dielectric materials available from Johanson Dielectrics, Inc.

FIG. 2A shows a schematic block diagram of a galvanically isolated DC-DC power converter assembly 200a comprising a plurality of serially interconnected individual resonant power inverters 211, 221, 231, 241 in accordance with a second embodiment of the invention. Inputs of the plurality of electrically interconnected individual resonant power inverters 211, 221, 231, 241 are serially connected to a dc or ac voltage or power source 203 via a positive input terminal 202a and a negative input terminal 201a of the assembly 200a. The skilled person will appreciate that the ordinary converter capacitor 212 of the previous converter embodiment connected in series with the positive output of the first resonant power inverter 211 has been replaced by a short circuit. Likewise, the ordinary converter capacitor 213 of the previous converter embodiment connected in series with the negative output of the fourth first resonant power inverter 241 has been left out and replaced by a short circuit.

This embodiment accordingly saves the costs and board space associated with these two ordinary converter capacitors compared to the previous embodiment. The skilled person will appreciate that any pair of the ordinary converter capacitors can be left out with the constraint that one of these capacitors is connected in series with a positive output of the resonant power inverters 211, 221, 231, 241 while the other capacitor is connected in series with a negative output of the resonant power inverters 211, 221, 231, 241. The skilled person will appreciate that this constraint in ap-plicable for any number interconnected resonant power inverters for example two, three, four, five etc. resonant power inverters.

FIG. 2B shows a schematic block diagram of a galvanically isolated DC-DC power converter assembly 200b comprising a plurality, e.g. between 1 and 200, of parallelly interconnected individual resonant power inverters 211, 241 in accordance with a third embodiment of the invention. In contrast to the previously discussed first and second galvanically isolated DC-DC power converter assemblies 200, 200a, the inputs of the plurality of resonant power inverters 211, 241 are connected in parallel to a common or shared dc or ac voltage or power source 203. This means that the individual resonant power inverters 211, 241 may be operating at the same dc bias voltage or dc bias point. Consequently, the previously discussed pair of converter capacitors connected series with each pair of positive and negative converter outputs (possibly lacking a single capacitor at each of the positive and negative summing nodes as discussed above) may be removed from the circuit. These pairs of converter capacitors may be replaced by respective pairs of short circuits, e.g. connecting traces or wiring, directly connecting the positive summing node 246 and the negative summing node 247 with the isolation capacitors 244b, 245b, respectively. The first isolation capacitor 244b is placed in-between the positive summing node 246b and a positive rectifier or load input 251b through an intervening shared resonant inductor L_{R} similarly to the previously discussed first embodiment of the invention. The second isolation capacitor 245b is placed in-between the negative summing node 247 and a negative rectifier input 252b.

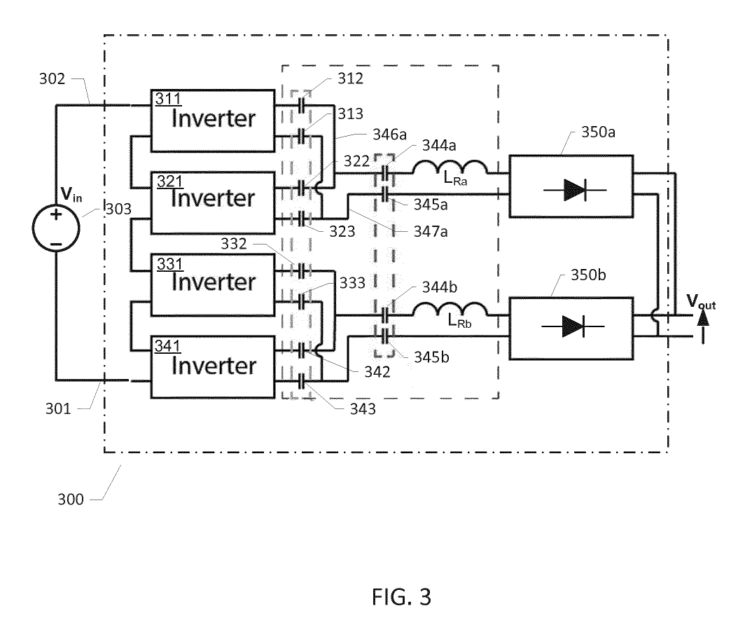

FIG. 3 shows a simplified schematic block diagram of a galvanically isolated DC-DC power converter assembly 300 comprising a first set of interconnected individual resonant power inverters and a second set of interconnected individual resonant power inverters in accordance with a fourth embodiment of the invention. The respective output nodes of the first set of resonant power inverters 311, 321 are coupled electrically in parallel to a first common load circuit 350a. The latter may comprise a rectification circuit. The respective output nodes of the second set of resonant power inverters 331, 341 are coupled electrically in parallel to a second common load circuit 350b. Respective dc output voltages of the first and second common load circuits 350a, 350b are coupled in parallel to generate the dc output voltage Vₒᵤₜ across a load of the assembly 300. The skilled person will understand that each of the first and second common load circuits 350a, 350b in other embodiments of the galvanically isolated DC-DC power converter assembly 300 may lack the rectifier portion or function in effect converting the assembly 300 to a DC-AC power converter assembly. The respective positive and negative inverter inputs or terminals of both the first and second sets of interconnected resonant power inverters 311, 321, 331, 341 are coupled electrically in series between a positive input terminal 302 and a negative input terminal 301 of the power converter assembly 300 for receipt of a dc or ac input voltage Vᵢₙ from an external voltage or power source 303. Consequently, the dc or ac input voltage Vᵢₙ is divided between the inputs of the individual resonant power inverters 311, 321, 331, 341 to produce a certain input voltage across each set of positive and negative inverter inputs as discussed above in connection with the first embodiment of the invention. The skilled person will understand that each of the first and second sets of interconnected individual resonant power inverters may comprise more than two individual resonant power inverters for example between 3 and 20 individual resonant power inverters. The individual resonant power inverters 311, 321, 331, 341 may possess identical circuit topologies, and different types of resonant power inverter topologies may be utilized in the galvanically isolated DC-DC power converter assembly 300, for example a power inverter topology selected from a group of {class E, class F, class DE} or any converter topology derived therefrom such as resonant SEPIC topology, resonant boost topology, class φ₂ topology, LLC topology or LCC topology.

As discussed above, the skilled person will understand that the positive and negative inverter inputs of the individual resonant power inverters 311, 321, 331, 341 in the alternative may be coupled electrically in parallel between the positive input terminal 302 and the negative input terminal 301 in which case some or all of the eight ordinary converter capacitors 312, 313, 322, 323, 332, 333, 342, and 343 may be eliminated and replaced by respective short-circuit connections.

The respective output nodes of the first set of resonant power inverters 311, 321 are coupled electrically in parallel to a positive summing node 346a and a negative summing node 347a where the respective output currents and output voltages of the first set of resonant power inverters 311, 321 are summed. The positive summing node 346a and the negative summing node 347a are connected through a first galvanic isolation barrier comprising a first pair of isolation capacitors 344a, 345a to positive and negative input terminals, respectively, of the first common rectification circuit 350a. The respective output nodes of the second set of resonant power inverters 331, 341 are coupled electrically in parallel to corresponding positive and negative summing nodes associated with the second common rectification circuit 350b. The latter positive and negative summing nodes are connected through a second galvanic isolation barrier, comprising a second pair of isolation capacitors 344b, 345b, to positive and negative input terminals, respectively, of the second common rectification circuit 350b. The skilled person will understand that the plurality of interconnected resonant power inverters 311, 321, 331, 341 may be magnetically coupled to each other in addition to the electrical coupling discussed above. The switching frequency of each of the resonant power inverters 311, 321, 331, 341 may be similar to the switching frequency discussed above in connection with the first embodiment of the invention. Each of the resonant power inverters 311, 321, 331, 341 comprises a first converter capacitor in series with the positive output node and a second converter capacitor in series with the negative output node similarly to the first embodiment of the galvanically isolated DC-DC power converter assembly 200 discussed above. The first and second series capacitors of each of the resonant power inverters 311, 321, 331, 341, e.g. converter capacitors 312 and 313 of the first power inverter 311, are ordinary without any official safety rating for the reasons discussed in detail above in connection with the first embodiment of the invention. The safety rated or compliant isolation from the mains of the galvanically isolated DC-DC power converter assembly 300 is instead provided by the first pair of isolation capacitors 344a, 345a and the second pair of isolation capacitors 344b, 345b. The first isolation capacitor 344a is placed in-between the positive summing node 346a and the positive load or rectifier input 351a of the first common load circuit 350a through an intervening shared resonant inductor L_{Ra} in a manner corresponding to the one discussed in detail above in connection with the first embodiment of the invention. The same applies for the second isolation capacitor 345a. The first and second isolation capacitors 344b, 345b are arranged in a similar manner in front of the second common load circuit 350b. The skilled person will appreciate that the locations of the first isolation capacitors 344a 344b and the shared resonant inductor L_{Rb} may be swapped in both instances such that each of the first and second isolation capacitors 344a, 344b becomes directly connected to the respective positive rectifier inputs. In yet other embodiment of the galvanically isolated DC-DC power converter assembly 300, each of the shared resonant inductors L_{R} has been replaced with individual resonant inductors arranged in a resonant network of each of the resonant power inverters 311, 321, 331, 341.

Each of the first and second isolation capacitors 344a, 345a and preferably also each of the first and second isolation capacitors 344b, 345b possesses an official safety rating for mains connected devices such as one of Y1, Y2, Y3, X1, X2 safety ratings for the reasons discussed in detail above in connection with the first embodiment of the invention. Likewise, the role of these eight ordinary converter capacitors 312, 313, 322, 323, 332, 333, 342, and 343 in the present DC-DC power converter assembly 300 is to provide ac coupling, or dc isolation, between the individual resonant power inverters 311, 321, 331 and 341 for the reasons discussed in detail above in connection with the first embodiment of the invention. Each of the first and second isolation capacitors 344a, 345a, 344b, 345b may possess the previously discussed electrical and physical characteristics of the isolation capacitors 244, 245 of the first embodiment of the invention.

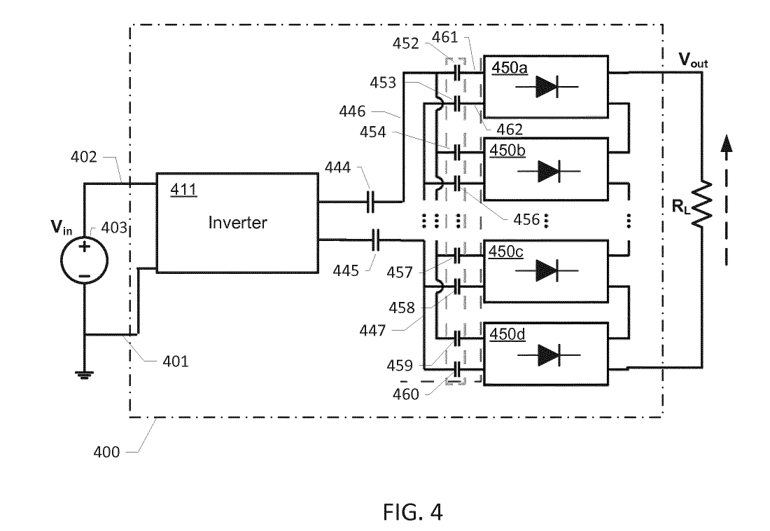

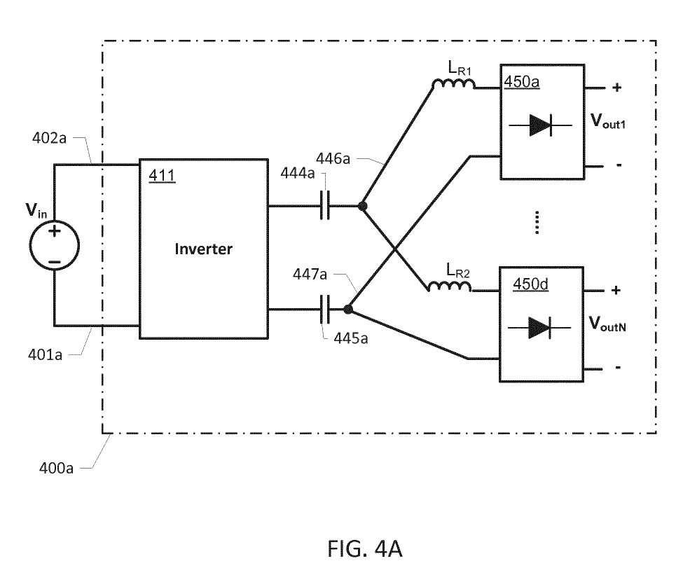

FIG. 4 shows a simplified schematic block diagram of a galvanically isolated DC-DC power converter assembly 400 comprising a first set of electrically interconnected individual load circuits 450a, 450b, 450c and 450d in accordance with a third embodiment of the invention. The skilled person will understand that alternative embodiments of the galvanically isolated DC-DC power converter assembly 400 may comprise fewer than four individual load circuits, for example two or three individual load circuits, while other alternative embodiments may comprise more than four individual load circuits. The plurality of interconnected individual load circuits 450a, 450b, 450c and 450d may possess identical circuit topologies. The galvanically isolated DC-DC power converter assembly 400 further comprises a common resonant power inverter 411, which is electrically coupled to the first set of electrically interconnected individual load circuits 450a, 450b, 450c and 450d via a capacitive galvanic isolation barrier as discussed in further detail below. The galvanically isolated DC-DC power converter assembly 400 may comprise different types of resonant power inverter topologies for example selected from a group of {class E, class F, class DE} or any converter topology derived therefrom such as resonant SEPIC topology, resonant boost topology, class φ₂ topology, LLC topology or LCC topology.

Each of the first set of individual load circuits 450a, 450b, 450c and 450d comprises a rectifier in the present embodiment. The skilled person will nevertheless understand that the load circuits in other embodiments of the galvanically isolated DC-DC power converter assembly 400 may lack the rectifier portion or functionality in effect converting the assembly 400 to a DC-AC power converter assembly. The output voltages of the individual load circuits 450a, 450b, 450c and 450d are coupled in series to produce a higher dc output voltage Vₒᵤₜ of the assembly for powering a converter assembly load R_{L}. The converter assembly load R_{L} may in practice include different types of electric loads for example a set of LED diodes or a rechargeable battery etc. In each of the individual load circuits 450a, 450b, 450c and 450d, a first load capacitor is connected in series with a positive load input, and a second load capacitor is connected in series with a negative load input. For the load circuit 450a, the first load capacitor 452 therefore has a first terminal coupled to a positive load input 461 while the second load capacitor 453 likewise has a first terminal coupled to the negative load input 462. First and second load capacitors 454, 456, 457, 458, 459, 460 are coupled in series with the respective positive and negative load inputs of the residual load circuits 450b, 450c and 450d in a corresponding manner. The DC-DC power converter assembly 400 comprises a positive summing node 446 which is connected to a second terminal of each of the first load capacitors 452, 454, 457, 459 of the first set of load circuits and a negative summing node 447 connected to a second terminal of each of the second load capacitors 453, 456, 458, 460 of the first set of load circuits. The skilled person will appreciate that the coupling of the positive summing node 446 and the negative summing node 447 arrange the inputs of the individual load circuits 450a, 450b, 450c and 450d in parallel electrically. The common resonant power inverter 411 is configured or adapted to produce a resonant output voltage at a switching frequency of the isolated DC-DC power converter assembly 400. This switching frequency may be identical to anyone of those discussed in connection with the second and third embodiments of the isolated DC-DC power converter assemblies 200, 300. The resonant output voltage and resonant output current are applied to the positive and negative summing nodes 446, 447 through a capacitive galvanic isolation barrier comprising a first common isolation capacitor 444 and a second common isolation capacitor 445.

Each of the first and second load capacitors 452, 453, 454, 456, 457, 458, 459, 460 is preferably an ordinary capacitor, such as an SMD compatible ceramics capacitor, without any official safety rating. These ordinary load capacitors 452, 453, 454, 456, 457, 458, 459, 460 do not provide a safety rated galvanic isolation of the individual load circuits 450a, 450b, 450c and 450d for the reasons discussed above. In contrast, each of the first and second isolation capacitors 444, 445 possesses an official safety rating for mains connected devices such as one of Y1, Y2, Y3, X1, X2 safety ratings for the reasons discussed in detail above in connection with the disclosure of the previous embodiments of the invention. Each of the first and second isolation capacitors 444, 445 may possess the previously discussed electrical and physical characteristics of the isolation capacitors 244, 245 of the first embodiment of the invention. Likewise, each of the first and second load capacitors 452, 453, 454, 456, 457, 458, 459, 460 may possess the previously discussed electrical and physical characteristics of the ordinary capacitors of the first and fourth embodiments of the invention. The role of these eight ordinary capacitors 452, 453, 454, 456, 457, 458, 459, 460 in the present DC-DC power converter assembly 400 is to provide ac coupling, or dc isolation, between the individual load circuits 450a, 450b, 450c and 450d for similar reasons as the ones discussed in detail above in connection with the first embodiment of the invention. Consequently, while the present DC-DC power converter assembly 400 comprises ten capacitors (a number increasing or decreasing with two capacitors for each addition or reduction of a load circuit), eight of these capacitors may be ordinary, small and cheap SMD compatible ceramics capacitors without any official safety rating. Only the first and second isolation capacitors 444, 445 possess an official safety rating and provide the safety isolation of the present DC-DC power converter assembly 400.

The skilled person will understand that a single capacitor of the four ordinary converter capacitors 452, 454, 457, and 459, which are connected to the positive summing node 446 may be eliminated despite the series connection of the converter outputs for the same reasons as those discussed above in connection with the first and second embodiments of the present galvanically isolated power converter assemblies 200, 200a. Likewise, a single capacitor of the four ordinary converter capacitors 453, 455, 458, and 460, which are connected to the negative summing node 447, may in a corresponding manner be eliminated.

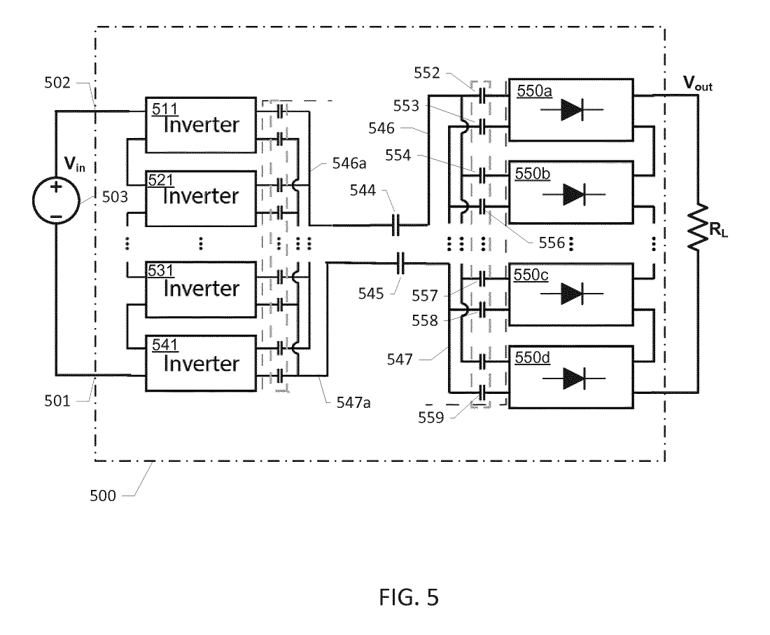

The skilled person will understand that alternative embodiments of the DC-DC power converter assembly 400 may comprise more than a single common power inverter for example two or more individual power inverters with respective outputs coupled in parallel to the safety rated galvanic isolation barrier. FIG. 5 shows a simplified schematic block diagram of such an alternative embodiment of the present invention. The galvanically isolated DC-DC power converter assembly 500 comprises a first set of electrically interconnected individual load circuits 550a, 550b, 550c and 550d connected in a similar manner to the previously discussed individual load cir-cults 450a, 450b, 450c and 450d of the previous embodiment. The individual load circuits 550a, 550b, 550c and 550d are coupled to a first positive summing node 546 and a first negative summing node 547 of assembly 500 in a similar manner to the previously discussed embodiment of the assembly 400. The power converter assembly 500 further comprises a safety rated galvanic isolation barrier comprising first and second isolation capacitors 544, 545 which possess an official safety rating for mains connected devices for the reasons discussed in detail above in connection with the disclosure of the first and fourth embodiments of the invention. Each of the first and second isolation capacitors 544, 545 may possess the previously discussed electrical and physical characteristics of the isolation capacitors 244, 245 of the first embodiment of the invention. The galvanically isolated DC-DC power converter assembly 500 comprises a plurality of electrically interconnected individual resonant power inverters 511, 521, 531, 541, for example two, three, four or even more individual resonant power inverters. The respective output nodes of the plurality of resonant power inverters 511, 521, 531, 541 are coupled electrically in parallel through respective series or converter capacitors to a second positive summing node 546a and a second negative summing node 547a where the respective output currents and output voltages of the plurality of resonant power inverters 511, 521, 531, 541 are summed. The series or converter capacitors at the output nodes of the individual resonant power inverters 511, 521, 531, 541 are ordinary capacitors without an official safety rating as discussed above in connection with the corresponding series capacitors e.g. 212, 213 of the fourth embodiment of the invention. The role of these ordinary converter capacitors in the present DC-DC power converter assembly 500 is to provide ac coupling, or dc isolation, between the individual resonant power inverters 511, 521, 531, 541 for the reasons discussed in detail above in connection with the first embodiment of the invention. Consequently, while the present DC-DC power converter assembly 500 comprises 18 capacitors, 16 of these capacitors may be ordinary, small and cheap SMD compatible ceramics capacitors without any official safety rating. The two residual capacitors, isolation capacitors 544, 545, are responsible for an efficient safety isolation of the present DC-DC power converter assembly 500. Hence, despite the use and interconnection of a plurality of resonant power inverters 511, 521, 531, 541 and a plurality of individual load circuits 550a, 550b, 550c and 550d, the safety isolation of the present DC-DC power converter assembly 500 requires only a small amount of capacitors.

FIG. 4A shows a simplified schematic block diagram of a galvanically isolated DC-DC power converter assembly 400a comprising a first set of electrically interconnected individual load circuits 450a, 450d in accordance with a sixth embodiment of the invention. The skilled person will understand that alternative embodiments of the galvanically isolated DC-DC power converter assembly 400 may comprise fewer than four individual load circuits, for example two or three individual load circuits, while other alternative embodiments may comprise more than four individual load circuits. The plurality of interconnected individual load circuits 450a, 450d may possess identical circuit topologies. The galvanically isolated DC-DC power converter assembly 400 further comprises a common or shared resonant power inverter 411 which is electrically coupled to the first set of electrically interconnected individual load circuits 450a, 450d via a capacitive galvanic isolation barrier comprising first and second isolation capacitors 444a, 445a. Each of the first and second isolation capacitors 444a, 445a possesses an official safety rating for mains connected devices such as one of Y1, Y2, Y3, X1, X2 safety ratings for the reasons discussed in detail above in connection with the disclosure of the previous embodiments of the invention. Each of the first and second isolation capacitors 444a, 445a may possess the previously discussed electrical and physical characteristics of the isolation capacitors 244, 245 of the first embodiment of the invention. The skilled person will understand that the inputs of the individual load circuits of the first set of electrically interconnected individual load circuits 450a, 450d are connected in parallel to a positive summing node 446a and a negative summing node 447a. The respective dc output voltages Vₒᵤₜ₁ to V_{ouN} of the individual load circuits are may be connected in parallel to each other or may be left unconnected to provide independent DC output voltages as illustrated.

In contrast to the previously discussed galvanically isolated power converter assembly 400, the inputs of the plurality of the individual load circuits 450a, 450d are connected in parallel. This means that the individual load circuits 450a, 450d may be operating at the same dc bias voltage or dc bias point. Consequently, the previously discussed pairs of load capacitors connected in series with the positive and negative load inputs (possibly lacking a single capacitor at each of the positive and negative summing nodes as discussed above) may be eliminated from the circuit. These pairs of load capacitors may be replaced by respective pairs of short circuits, e.g. connecting traces or wiring, directly connecting the positive summing node 446a and the negative summing node 447a with the isolation capacitors 444a, 445a, respectively.

The skilled person will understand that the sharing of the first and second isolation capacitors 444a, 445a between the plurality of interconnected individual load circuits 450a, 450d saves board space, component costs and assembly costs.

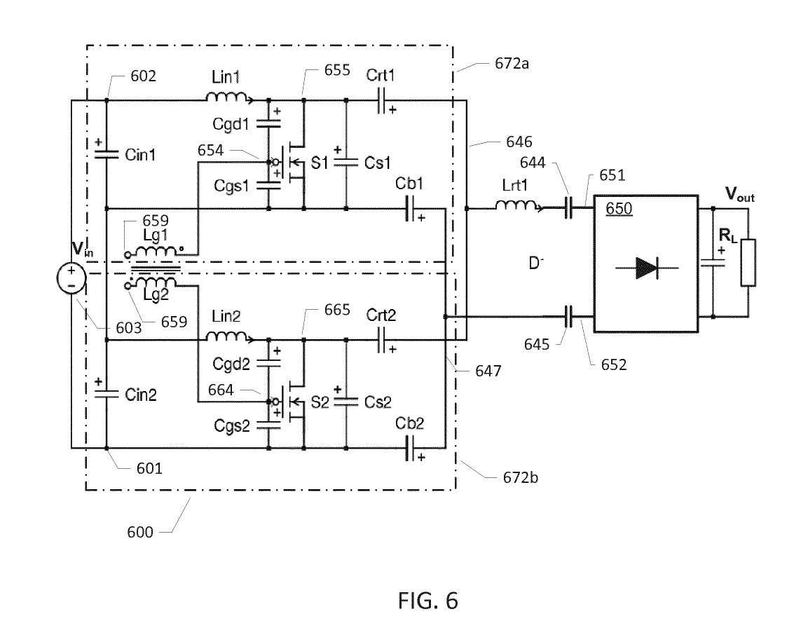

FIG. 6 shows a simplified electrical circuit diagram of a galvanically isolated resonant DC-DC power converter assembly 600 comprising first and second magnetically coupled resonant class E power inverters 672a, 672b connected to a common or shared rectification circuit 670 in accordance with an eight embodiment of the invention. The galvanically isolated resonant DC-DC power converter assembly 600 comprises two individual resonant class E inverters 672a, 672b with respective outputs combined in parallel at a positive summing node 646 and a negative summing node 647. In the alternative, the present resonant class E inverters 672a, 672b may be replaced by resonant class DE power inverters. The respective positive and negative inverter inputs or terminals of the resonant class E power inverters 672a, 672b are coupled electrically in series between a positive input terminal 602 and a negative input terminal 601 of the assembly 600 for receipt of a dc or ac input voltage Vᵢₙ from an external voltage or power source 603. Consequently, the dc or ac input voltage Vᵢₙ is divided between the individual resonant class E power inverters 672a, 672b to produce a certain input voltage across each set of positive and negative inverter inputs. The positive summing node 646 and the negative summing node 647 are connected through a galvanic isolation barrier comprising a pair of isolation capacitors 644, 645, to positive and negative input terminals, respectively, of the common rectification circuit 650. The common rectification circuit 650 may for example comprise a class E topology. The output voltage Vₒᵤₜ of the common rectification circuit 650 is connected to a converter assembly load R_{L}. The converter assembly load R_{L} may in practice include different types of electric loads for example a set of LED diodes or a rechargeable battery etc. The first class E power inverter 672a comprises a first semiconductor switch S1 configured to drive the resonant network according to well-known principles and the second class E power inverter 672b comprises a second semiconductor switch with a corresponding role in the second power inverter. The skilled person will understand that each of the first and second semiconductor switches S1, S2 may comprise a transistor such as a MOSFET or IGBT, for example a Gallium Nitride (GaN) or Silicon Carbide (SiC) MOSFET. The output voltage Vₒᵤₜ may be adjusted to a desired or reference dc voltage level by an output voltage regulation loop (not shown). The output voltage regulation loop may comprise feedback control and one or more suitable dc reference voltage(s). The output voltage regulation loop may be configured for frequency modulation, burst-mode or on-off control of the converter assembly output voltage Vₒᵤₜ. In one embod-invent, the output voltage Vₒᵤₜ of the converter assembly is controlled by adjusting respective adjustable bias voltages applied to the free ends 659, 669 of the first and second gate inductors Lg1, Lg2. These adjustable bias voltages are preferably configured such that substantially identical gate-source voltages are applied to S1 and S2 to allow tracking operation of the first and second Class E power inverters 672a, 672b. This means that the switching frequencies of the first and second Class E power inverters 672a, 672b become substantially identical and synchronous and in-phase. The switching frequency of each class E power inverter is preferably set to a frequency at or above 10 MHz or above 20 MHz, or even 30 MHz to in the latter case provide so-called VHF operation of the isolated resonant DC-DC power converter assembly 600.

The safety rated galvanic isolation of the galvanically isolated DC-DC power converter assembly 600 is provided by the first and second isolation capacitors 644, 645 in a similar manner as the one discussed before in connection with the first embodiment of the invention. The first isolation capacitor 644 is placed in-between the positive summing node 646 and a positive rectifier input 651 with an intervening shared resonant inductor L_{R}. The second isolation capacitor 645 is placed in-between the negative summing node 647 and a negative rectifier input 652. The first resonant isolated class E inverter 672a comprises a first capacitor Crt1 in series with a positive output node of the inverter 672a and a second capacitor Cb1 in series with a negative output. Likewise, the second resonant isolated class E inverter 672b comprises a first capacitor Crt2 in series with a positive output node of the inverter 672b and a second capacitor Cb2 in series with a negative output. However, each of these series capacitors Crt1, Crt2, Cb1, Cb2 is an ordinary capacitor, such as SMD compatible ceramic capacitors, without any safety rating. The skilled person will understand that one of the two series capacitors Crt1 and Crt2 may be eliminated from the circuit in an alternative embodiment for the reasons discussed above. The same applies to one of the two series capacitors Cb1 and Cb2.

The galvanic isolation from the mains voltage of the DC-DC power converter assembly 600 is provided by the first and second isolation capacitors 644, 645. The skilled person will appreciate that the positions of the first isolation capacitor 644 and the shared resonant inductor L_{R} may be swapped such that the first isolation capacitor 644 is coupled directly to the positive rectifier input 651. In further alternative embodiments of the galvanically isolated DC-DC power converter assembly 600, the shared resonant inductor L_{R} is replaced with individual resonant inductors arranged in the resonant network of each of the resonant power inverters 672a, 672b. Each of the first and second isolation capacitors 644, 545 possesses an official safety rating for mains connected devices such as anyone of Y1, Y2, Y3, X1 and X2 safety ratings to ensure that the combined output voltage and current of class E inverters 672a, 672b is appropriately insulated from the common rectification circuit 650 such that the primary side circuitry of the DC-DC power converter assembly 600 is electrically safety insulated from the secondary side circuitry of the DC-DC power converter assembly 600.

The skilled person will understand that characteristics of the first and second isolation capacitors 644, 645 and the series capacitors Crt1, Crt2, Cb1 and Cb2 of the present resonant DC-DC power converter assembly 600 may be identical to the characteristics of the corresponding components of the above-discussed DC-DC power converter assembly 200. The DC-DC power converter assembly 600 comprises the above-mentioned first and second gate inductors Lg1, Lg2 in series with the gates of the first and second controllable semiconductor switches S1, S2, respectively. The first and second gate inductors Lg1 and Lg2 are magnetically coupled as indicated and arranged or oriented to force substantially 0 degree phase shift between the corresponding resonant voltage and current waveforms of the resonant class E inverters 672a, 672b. The arrangement and orientation of the gate series inductors Lg1, Lg2 therefore force approximately 0 degree phase shift between first and second switch control signals applied to the gate terminals 654, 664, respectively. The 0 degree phase shift between the corresponding resonant voltage and current waveforms of the resonant isolated class E inverters 672a, 672b allows the respective output voltages of the first and second resonant networks, comprising Crt1, Crt2 and Lrt1, to be combined or added at the input of the common rectification circuit 650 without attenuation because of their in-phase relationship. The skilled person will understand that the first and second resonant networks share the resonant inductor Lrt1 as discussed above.

1. A galvanically isolated power converter assembly comprising:
a first set of electrically interconnected resonant power inverters configured for generating respective output voltages and output currents,
a first positive summing node and a first negative summing node configured for combining the output voltages and output currents of the first set of resonant power inverters,
a first common load circuit comprising a positive load input and a negative load input, and
a galvanic isolation barrier comprising a first common isolation capacitor coupled in series between the first positive summing node and the positive load input of the common load circuit and a second common isolation capacitor coupled in series between the first negative summing node and the negative load input of the first common load circuit;
wherein each of the first and second common isolation capacitors possesses an official safety rating.

2-20. (canceled)

21. The galvanically isolated power converter assembly according to claim 1, comprising a positive power input and a negative power input for receipt of energy from a voltage source or a current source;
wherein respective positive and negative inverter inputs of the first set of electrically interconnected resonant power inverters are coupled in series between the positive power input and negative power input.

22. The galvanically isolated power converter assembly according to claim 1, comprising a positive power input and a negative power input for receipt of energy from a voltage source or a current source;
wherein respective positive and negative inverter inputs of the first set of electrically interconnected resonant power inverters are coupled in parallel between the positive power input and negative power input.

23. The galvanically isolated power converter assembly according to claim 21, wherein each resonant power inverter, of the first set of electrically interconnected resonant power inverters, comprises at least one of a first converter capacitor connected in series with a positive output node and a second converter capacitor in series with a negative output node;
wherein the at least one of the first and second converter capacitors lacks an official safety rating.

24. The galvanically isolated power converter assembly according to claim 23, wherein the first converter capacitor is connected between the positive output node of the resonant power inverter and the positive summing node and/or the second converter capacitor is connected between the negative output node of the resonant power inverter and the first negative summing node.

25. The galvanically isolated power converter assembly according to claim 1, wherein the first set of resonant power inverters comprises a plurality of individual resonant power inverters with identical circuit topologies.

26. The galvanically isolated power converter assembly according to claim 23, wherein the at least one of the first and second converter capacitors possesses a first break down voltage rating;
wherein each of the first and second common isolation capacitors possesses a second break down voltage rating;
wherein the second break down voltage rating is higher than the first break down voltage rating.

27. The galvanically isolated power converter assembly according to claim 26, wherein the second voltage breakdown rating of the least one of the first and second common isolation capacitors is higher than 250 VAC.

28. The galvanically isolated power converter assembly according to claim 1, wherein the first common load circuit comprises a rectifier.

29. The galvanically isolated power converter assembly according to claim 1, wherein each of the first and second common isolation capacitors possesses a safety rating selected from a group of {Y1, Y2, Y3, X1, X2}.

30. The galvanically isolated power converter assembly according to claim 1, wherein the first common isolation capacitor comprises a surface mount compatible ceramic chip capacitor and the second common isolation capacitor comprises a surface mount compatible ceramic chip capacitor.

31. The galvanically isolated power converter assembly according to claim 1, wherein a capacitance of each of the first and second common isolation capacitors is larger than 10 pF.

32. The galvanically isolated power converter assembly according to claim 26, wherein the first breakdown voltage rating is less than 240 VAC.

33. The galvanically isolated power converter assembly according to claim 1, wherein resonant networks of the first set of resonant power inverters comprise a shared resonant inductor coupled between the positive summing node and the positive input terminal of the first common load circuit and thereby placed in series with the first common isolation capacitor.

34. The galvanically isolated power converter assembly according to claim 1, wherein the first set of resonant power inverters are magnetically coupled to each other to synchronize resonant current and voltage waveforms between individual resonant power inverters including the output voltages and output current waveforms.

35. The galvanically isolated power converter assembly according to claim 1, further comprising:
a second set of electrically interconnected resonant power inverters configured for generating respective output voltages and output currents,
a second positive summing node and a second negative summing node configured for combining the output voltages and output currents of the second set of resonant power inverters,
a second common load circuit comprising a positive load input and a negative load input, and
a third common isolation capacitor coupled in series between the second positive summing node and the positive load input of the second common load circuit, and a fourth common isolation capacitor coupled in series between the second negative summing node and the negative load input of the second common load circuit;
wherein each of the third and fourth common isolation capacitors possesses an official safety rating.

36. The galvanically isolated power converter assembly according to claim 35, wherein an output of the first common load circuit and an output of the second common load circuit are coupled in series between positive and negative load connection terminals of the assembly.

37. The galvanically isolated power converter assembly according to claim 1, wherein each resonant power inverter of the first set of resonant power inverters comprises:
an input side circuit comprising a positive and a negative input terminal for receipt of a first input voltage,
a controllable switch arrangement driven by a first switch control signal to set a switching frequency of the power inverter, and
a resonant network coupled to an output of the first controllable switch arrangement to generate alternatingly increasing and decreasing resonant current in the resonant network in accordance with the first switch control signal to produce an output voltage between the positive and negative output nodes.

38. A galvanically isolated power converter assembly comprising:
a first set of electrically interconnected load circuits comprising respective positive and negative load inputs,
a common resonant power inverter configured to generate a resonant output voltage between a positive inverter output node and negative inverter output node, and
a galvanic isolation barrier comprising a first common isolation capacitor coupled between the positive summing node and the positive inverter output node and a second common isolation capacitor coupled in series between the negative summing node and the negative inverter output node;
wherein each of the first and second common isolation capacitors possesses an official safety rating.

39. The galvanically isolated power converter assembly according to claim 38, wherein each load circuit, of the first set of electrically interconnected load circuits, comprises at least one of a first load capacitor having a first terminal coupled to the positive load input and a second load capacitor having a first terminal coupled to the negative load input;
wherein the at least one of the first and second load capacitors lacks an official safety rating;
wherein a second terminal of each of the first load capacitors is connected to the positive summing node and a second terminal of each of the second load capacitors is connected to the negative summing node to arrange the positive load inputs and the negative load inputs electrically in parallel.
